(19) United States
(12) Patent Application Publication
(10) Pub. No.: US 2018/0039371 A1
(43) Pub. Date: Feb. 8, 2018

(54) ELECTRONIC APPARATUS AND CONTROLLING METHOD THEREOF

(71) Applicant: SAMSUNG ELECTRONICS CO., LTD., Suwon-si (KR)

(72) Inventors: Chang-seog KO, Hwaseong-si (KR); Seok-hyun KIM, Suwon-si (KR); Jung-geun KIM, Suwon-si (KR)

(21) Appl. No.: 15/450,137

(22) Filed: Mar. 6, 2017

(30) Foreign Application Priority Data
Aug. 2, 2016 (KR) 10-2016-0098322

(51) Int. Cl. G06F 3/041; G06F 3/045; H04N 21/472; H04N 21/81; H04N 21/422; H04N 21/41; G06F 3/044; G06F 3/0484

(52) U.S. Cl. CPC G06F 3/0416; G06F 3/044; G06F 3/045; G06F 3/04845; H04N 21/816; H04N 21/42224; H04N 21/42209; H04N 21/4126; H04N 21/4122; H04N 21/47202; G06F 2203/04105; G06F 2203/04104; G06F 2203/04808; G06F 2203/04806

(57) ABSTRACT

An electronic apparatus is disclosed. The electronic apparatus includes communication circuitry configured to communicate with a display apparatus which displays an image of a viewpoint of a panoramic image; a touch screen configured to display a substantially circular user interface (UI); and a processor, in response to a point on the substantially circular UI being touched, configured to transmit a control signal to display an image of a viewpoint corresponding to the touched point of the panoramic image to the display apparatus through the communication circuitry.

### CROSS-REFERENCE TO RELATED APPLICATION

This application is based on and claims priority under 35 U.S.C. § 119 to Korean Patent Application No. 10-2016-0098322, filed in the Korean Intellectual Property Office on Aug. 2, 2016, the disclosure of which is incorporated by reference herein in its entirety.

### BACKGROUND

### 1. Field

The present disclosure relates generally to an electronic apparatus and a controlling method thereof, and for example, to an electronic apparatus that can easily control a panoramic image displayed on a display apparatus and a controlling method thereof.

### 2. Description of Related Art

Thanks to electronics development, various types of electronic products are developed and supplied. Specifically, various photographing apparatuses such as a cell phone, a laptop computer, a personal digital assistant (PDA) and the like are used in most homes.

As use of photographing apparatus has been increased, user needs for more various functions also has been increased. Accordingly, products with new functions are coming out according to many manufacturers' efforts to meet the user needs.

Recently, photographing apparatuses with a function of generating a panoramic image by using images photographed at a plurality of viewpoints are developed. Regarding such a panoramic image, it is normal for a user to appreciate the panoramic image by moving viewpoints through a virtual reality (VR) apparatus or a mobile phone.

Meanwhile, even though it is normal to use a remote controller when a user watches a panoramic image on a big screen such as a TV screen, there are difficulties in moving to a desired viewpoint of a panoramic image, minimizing and/or reducing an image and enlarging an image with a remote controller having four direction keys, etc.

### SUMMARY

Various example embodiments relate to an electronic apparatus that can easily control a panoramic image displayed on a display apparatus and a controlling method thereof.

As aspect of an example embodiment relates to an electronic apparatus, including: a communicator comprising communication circuitry configured to communicate with a display apparatus configured to display an image of a viewpoint of a panoramic image; a touch screen configured to display a substantially circular user interface (UI); and a processor, in response to a point on the substantially circular UI being touched, configured to transmit a control signal to display an image of a viewpoint of the panoramic image corresponding to the touched point to the display apparatus through the communicator.

The processor, in a state that an image of a first viewpoint corresponding to a first point of the substantially circular UI is displayed on the display apparatus, in response to a second point of the substantially circular UI being touched, may transmit a control signal to display an image of a second viewpoint that is moved from the first viewpoint by as much as an angle between the first point and the second point with reference to a center of the substantially circular UI, to the display apparatus through the communicator.

The substantially circular UI may be divided into a plurality of areas respectively corresponding to a plurality of viewpoints.

The processor may control the touch screen such that, among the plurality of areas, an area corresponding to a viewpoint of an image which is displayed on the display apparatus is displayed distinctively from another area.

The processor, in response to a point of the substantially circular UI being touched for more than a pre-set period of time, may display an image of a viewpoint corresponding to the touched point of the panoramic image through the touch screen.

The processor, in a state that the display apparatus and the touch screen respectively display an image of a viewpoint of the panoramic image, in response to a control authority over the electronic apparatus being set on the substantially circular UI and a point of the circular UI being touched, may control the touch screen to display an image of a viewpoint corresponding to the touched point.

The processor, in a state that an image of a first viewpoint of the panoramic image is displayed on the display apparatus and an image of a second viewpoint of the panoramic image is displayed on the touch screen, in response to an image of a second viewpoint displayed on the touch screen being touched and a dragging manipulation in an outside direction of the electronic apparatus being sensed, may control the touch screen to display the image of the first viewpoint and control the communicator to transmit a control signal to display the image of the second viewpoint, to the display apparatus.

The processor, in response to the dragging manipulation being sensed, through the communicator, may receive the image of the first viewpoint from the display apparatus and transmit viewpoint information corresponding to the image of the second viewpoint to the display apparatus.

The processor may control the touch screen to further display a second substantially circular UI in addition to the substantially circular UI and, in response to a point on the second substantially circular UI being touched, display an image of a viewpoint corresponding to the touched point of the panoramic image on the touch screen.

The processor, in response to a dragging manipulation being sensed on a second area that is distinguished from a first area displaying the substantially circular UI, may transmit a control signal to move a viewpoint of the panoramic image displayed on the display apparatus based on a direction in which the dragging manipulation is made, to the display apparatus through the communicator.

The processor, in response to two points being touched on the second area and a manipulation of changing a distance between the two points being sensed, may control the communicator to transmit a control signal to zoom in or zoom out an image which is displayed on the display apparatus based on the changed distance, to the display apparatus.

The processor, in response to a center of the substantially circular UI being touched, may control the communicator to transmit a control signal to display an image of a default viewpoint of the panoramic image to the display apparatus.

The apparatus may further include a sensor configured to sense a movement of the electronic apparatus, wherein the processor controls the communicator to transmit a control signal to move a viewpoint of the panoramic image displayed on the display apparatus based on a movement change of the electronic apparatus sensed by the sensor, to the display apparatus.

The processor may control the communicator to receive state information from the display apparatus and, in response to determining that an image of a viewpoint of the panoramic image is displayed on the display apparatus based on the received state information, control the touch screen to display the circular UI.

According to an aspect of another example embodiment, method of controlling an electronic apparatus is provided, including: connecting a display apparatus which displays an image of a viewpoint of a panoramic image with the electronic apparatus; displaying a substantially circular UI; and in response to a point of the circular UI being touched, transmitting a control signal to display an image of a viewpoint corresponding to the touched point of the panoramic image to the display apparatus.

The transmitting may include, in a state that an image of a first viewpoint corresponding to a first point of the substantially circular UI is displayed on the display apparatus, in response to a second point of the substantially circular UI being touched, transmitting a control signal to display an image of a second viewpoint that is moved from the first viewpoint by as much as an angle between the first point and the second point with reference to a center of the substantially circular UI, to the display apparatus through the communicator.

The method of controlling the electronic apparatus may further include, in response to a point of the substantially circular UI being touched for more than a pre-set period of time, displaying an image of a viewpoint corresponding to the touched point of the panoramic image on the electronic apparatus.

The method of controlling the electronic apparatus may further include, in a state that an image of a first viewpoint of the panoramic image is displayed on the display apparatus and an image of a second viewpoint of the panoramic image is displayed on the electronic apparatus, in response to an image of a second viewpoint displayed on the electronic apparatus being touched and a dragging manipulation in an outside direction of the electronic apparatus being sensed, displaying the image of the first viewpoint on the electronic apparatus and transmitting a control signal to display the image of the second viewpoint, to the display apparatus.

The method of controlling the electronic apparatus may further include receiving state information from the display apparatus and the displaying the substantially circular UI may include, in response to determining that an image of a viewpoint of the panoramic image is displayed on the display apparatus based on the received state information, controlling the touch screen to display the substantially circular UI.

According to an aspect of another example embodiment, a computer-readable recording medium is provided, including a program which, when executed by a processor, causes an electronic apparatus to perform operations comprising: connecting a display apparatus which displays an image of a viewpoint of a panoramic image with the electronic apparatus; displaying a substantially circular UI; and in response to a point of the circular UI being touched, transmitting a control signal to display an image of a viewpoint corresponding the touched point of the panoramic image to the display apparatus.

### BRIEF DESCRIPTION OF THE DRAWINGS

The above aspects, features and attendant advantages of the present disclosure will be more readily understood and appreciated from the following detailed description, taken in conjunction with the accompanying drawings, in which like reference numerals refer to like elements, and wherein:

FIG. 1 is a diagram illustrating an example display system according to an example embodiment of the present disclosure;

FIG. 2 is a block diagram illustrating an example configuration of an electronic apparatus according to an example embodiment of the present disclosure;

FIGS. 3 and 4 are diagrams illustrating example UI(s) provided by an electronic apparatus according to various example embodiments of the present disclosure;

FIG. 5 is a diagram illustrating example images of various viewpoints of a panoramic image;

FIGS. 6, 7 and 8 are diagrams illustrating example methods of moving a viewpoint of a panoramic image displayed on a display apparatus using a substantially circular UI of an electronic apparatus according to various example embodiments of the present disclosure;

FIGS. 9, 10 and 11 are diagrams illustrating example methods of moving a viewpoint of a panoramic image displayed on a display apparatus according to various touch manipulations on the electronic apparatus according to various example embodiments of the present disclosure;

FIGS. 12 and 13 are diagrams illustrating example methods of displaying a viewpoint of a panoramic image on an electronic apparatus according to various example embodiments of the present disclosure;

FIG. 14 is a diagram illustrating an example exchange of images between a display apparatus and an electronic apparatus according to an example embodiment of the present disclosure;

FIG. 15 is a diagram illustrating an example movement to a default viewpoint of a panoramic image according to an example embodiment of the present disclosure;

FIG. 16 is a flowchart illustrating an example method of controlling an electronic apparatus according to an example embodiment of the present disclosure; and

FIG. 17 is a diagram illustrating an example method of displaying various viewpoints of a panoramic image on a display apparatus and a plurality of electronic apparatuses according to an example embodiment.

### DETAILED DESCRIPTION

Hereinafter, the terms used in describing the various example embodiments will be briefly explained, and example embodiments are described in greater detail with reference to the accompanying drawings.

Although the terms used in the example embodiments are general terms, which are widely used at the present time considering the functions in the present disclosure, the terms may be changed depending on an intention of a person skilled in the art, a precedent, and introduction of new technology. In addition, in a special case, terms that are arbitrarily selected may be used. In this case, the meaning of the terms will be explained in detail in the corresponding detailed descriptions. Accordingly, the terms used in the description should not necessarily be construed as simple names of the terms, but be defined based on meanings of the terms and overall contents of the present disclosure.

The example embodiments may vary, and may be provided in different example embodiments. Various example embodiments are described with reference to accompanying drawings. However, this is not intended to limit the scope to an example embodiment, and therefore, it should be understood that all the modifications, equivalents or substitutes included under the spirit and technical scope are encompassed. While describing example embodiments, if it is determined that the specific description regarding a known technology might obscure the gist of the disclosure, the specific description may be omitted.

In the present disclosure, relational terms such as first and second, and the like, may be used to distinguish one entity from another entity, without necessarily implying any actual relationship or order between such entities.

It is to be understood that the singular forms “a,” “an,” and “the” include plural referents unless the context clearly dictates otherwise. The terms, “include”, “comprise”, “is configured to”, etc. of the description are used to indicate that there are features, numbers, steps, operations, elements, parts or combination thereof, and they do not exclude the possibilities of combination or addition of one or more features, numbers, steps, operations, elements, parts or combination thereof.

In an example embodiment, ‘a module’ or ‘a unit’ performs at least one function or operation, and may be realized as hardware (e.g., circuitry), firmware, software, or combination thereof. In addition, a plurality of ‘modules’ or ‘units’ may be integrated into at least one module and may be realized as at least one process or processor (not shown) except for ‘modules’ or ‘units’ that should be realized in specific hardware.

The example embodiments of the disclosure will be described in greater detail below in a manner that will be understood by one of ordinary skill in the art. However, example embodiments may be realized in a variety of different configurations, and not limited to descriptions provided herein. Further, those descriptions that are irrelevant to the disclosure may be omitted so as to describe example embodiments more clearly, and similar drawing reference numerals are used for the similar elements throughout the description.

Hereinafter, the present disclosure will be explained in further detail with reference to the drawings attached.

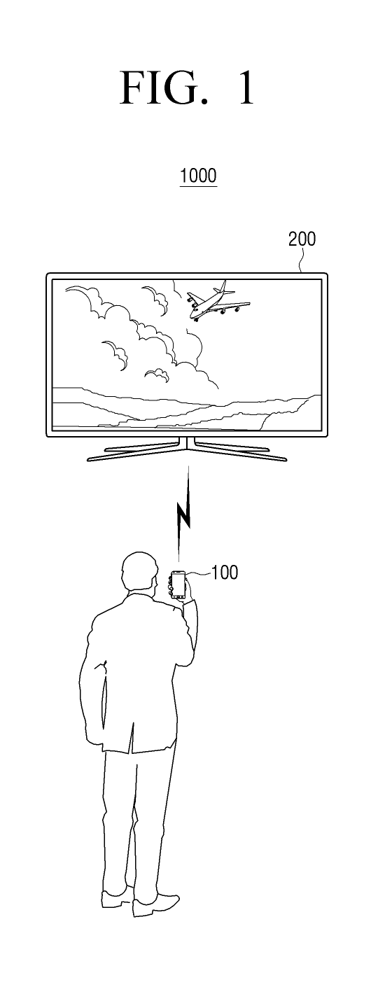

FIG. 1 is a diagram illustrating an example display system 1000 according to an example embodiment of the present disclosure.

Referring to FIG. 1, the display system 1000 includes an electronic apparatus 100 and a display apparatus 200 controlled by the electronic apparatus 100. The electronic apparatus 100 and the display apparatus 200 may be operably connected with each other and transcieve a control signal, an image, etc.

For example, the electronic apparatus 100 may be an apparatus including a manipulation part to control an image that is displayed on the display apparatus 200 and may be embodied as various electronic apparatuses such as a smartphone, a tablet personal computer (PC), a laptop computer, a desktop PC, a remote controller, a wearable device and the like, but is not limited thereto. The electronic apparatus 100 may include at least one of a touch screen, a physical button, a keyboard, a mouse, a motion sensing sensor, a pressure sensing sensor and the like that can receive a user manipulation to control an image displayed on the display apparatus 200, but is not limited thereto.

The display apparatus 200 may refer, for example, to an apparatus to display an image and the display apparatus 200, for example, may be a TV, a tablet PC, a laptop computer, a desktop PC, a projector or the like, but is not limited thereto.

The display apparatus 200 may receive a control signal based on a user manipulation made on the electronic apparatus 100 and execute an operation based on the control signal. According to an example embodiment, the display apparatus 200 may display a panoramic image and move a viewpoint of the panoramic image based on the control signal received from the electronic apparatus 100.

The panoramic image may refer, for example, to an image having various viewpoints and the panoramic image, for example, may be an image which is generated by combining a plurality of images that are photographed by one camera being moved, an image generated by combining a plurality of images photographed by many cameras at different viewpoints in an identical space, or an image photographed by a camera which have a wide view angle, or the like, but is not limited thereto. In addition, the panoramic image is not limited to an image photographed by a camera. For example, artificially produced content such as a game image may also be the panoramic image. Meanwhile, an image includes a still image and a video.

The panoramic image also includes a 360 degree panoramic image. The 360 degree panoramic image may refer, for example, to an image whose start and end are the same and the 360 degree panoramic image may be referred to using various names such as a spherical image, an omni-directional image and the like. For example, in case that a user watches a 360 degree panoramic image through the display apparatus 200, the user may easily move a viewpoint to a desired viewpoint by using a UI provided on the electronic apparatus 100.

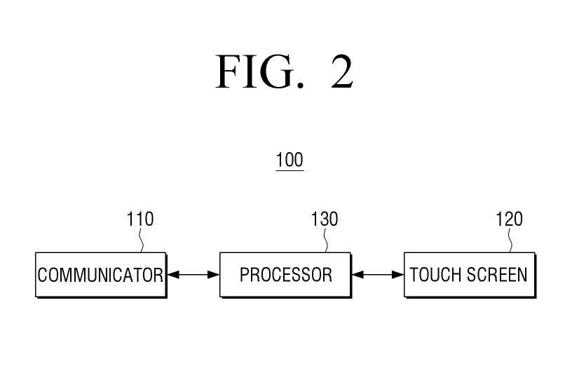

An example configuration of the electronic apparatus 100 may be explained in more detail with reference to FIG. 2.

Referring to FIG. 2, the electronic apparatus 100 includes a communicator (e.g., including communication circuitry) 110, a touch screen 120 and a processor (e.g., including processing circuitry) 130.

The communicator 110 may include various communication circuitry for a communication between the electronic apparatus 100 and an external apparatus. The communicator 110 may connect the electronic apparatus 100 with an external apparatus in a wireless communication method or a wired communication method. The communicator 110 may include various communication circuitry, such as, for example, and without limitation, a WiFi chip, a Bluetooth chip, a Near Field Communication (NFC) chip, a wireless communication chip, and/or the like. In this case, the WiFi chip, the Bluetooth chip, the NFC chip respectively perform communication by using WiFi, Bluetooth, and NFC. The NFC chip may correspond to a chip which operates with the Near Field Communication (NFC) method using 13.56 MHz, from among various RF-ID frequency bands such as 135 kHz, 13.56 MHz, 433 MHz, 860-960 MHz, and 2.45 GHz, and/or the like. In case of using the WiFi chip or the Bluetooth chip, various connection information such as a Service Set Identification (SSID), a session key, and/or the like may be transceived first, and by using the connection information, communication is connected, and then various information may be transceived. A wireless communication chip may refer, for example, to a chip that communicates according to various communication protocols, such as an IEEE, a ZigBee, a 3rd Generation (3G), a 3rd Generation Partnership (3GP), a Long Term Evolution (LTE), and the like.

In order to control a panoramic image displayed on the display apparatus 200, it is necessary that the electronic apparatus 100 and the display apparatus 200 are operably connected with each other. Example methods of connecting the electronic apparatus 100 with the display apparatus 200 are as follows.

For example, in case that an NFC communication between the display apparatus 200 and the electronic apparatus 100 is possible, if the electronic apparatus 100 approaches (is detected by) the display apparatus 200, the electronic apparatus 100 may be automatically connected with the display apparatus 200.

As another example, the electronic apparatus 100 and the display apparatus 200 may be connected through an authentication via ultrasonic waves and the Bluetooth. For example, the display apparatus 200 may include an apparatus which can generate ultrasonic waves. It is difficult for ultrasonic waves to pass through a wall and accordingly, the electronic apparatus 100 may recognize that the display apparatus 200 is in a space where the electronic apparatus 100 is present by receiving ultrasonic waves generated by the display apparatus 200. As such, if it is certain that the electronic apparatus 100 and the display apparatus 200 are in one space, the electronic apparatus 100 may be connected with the display apparatus 200 via Bluetooth.

In addition to the display apparatus 200, the electronic apparatus 100 may also control another external apparatus. In this case, the electronic apparatus 100 may display a list of apparatuses that can be controlled by the electronic apparatus 100, and if the display apparatus 200 is selected among the apparatuses, the electronic apparatus 100 may be connected with the display apparatus 200 in a pre-set wireless communication method.

In addition to the NFC and the Bluetooth connecting methods, the electronic apparatus 100 may be connected with the display apparatus 200 through various wireless communication methods such as a WiFi connection, a WiFi direct connection method and the like. In addition to the wireless communication methods, the electronic apparatus 100 may also be connected with the display apparatus 200 through a wired connection method.

As another example, the electronic apparatus 100 may control the display apparatus 200 using an infrared (IR) signal.

The touch screen 120 can receive a touch manipulation of a user by displaying a screen. A touch sensor included in the touch screen 120 may be embodied in various ways, such as, for example, and without limitation, a capacitive touch sensor or a resistive touch sensor. A capacitive touch sensor, when a part of a user's body touches a surface of the touch screen 120, senses imperceptible electricity caused by the body of the user and calculates (determines) touch coordinates. A resistive touch sensor including two electrode plates, when a user touches the touch screen 120, senses electricity flowing by an upper plate and a lower plate of the touched point contacting each other and calculates (determines) touch coordinates.

In addition, the touch screen 120 may include a pressure sensor and sense an intensity of a touch by a user. The pressure sensor may be included in the touch screen 120 and include a piezo film to output an electric signal corresponding to the intensity of the pressure. Meanwhile, if the touch sensor is embodied as a resistive touch sensor, the resistive touch sensor may also function as a pressure sensor.

The touch screen 120 may display various UIs and receive a touch manipulation with respect to a UI. For example, the touch screen 120 may display a circular (e.g., substantially circular) UI to control a panoramic image displayed on the display apparatus 200. Descriptions of the circular UI will be described in greater detail hereinafter. It will be understood that the term “substantially circular” when used in connection with the UI herein encompasses both a circular UI and/or a UI that is not perfectly circular, but has a curved appearance, or is more or less circular. Moreover, the term “circular” when used in connection with the UI herein encompasses “substantially circular.” It will also be understood that while a substantially circular UI is described in detail herein, that there is no limitation to the shape, size and/or appearance of the UI, and that any form of UI is contemplated and may be used.

Meanwhile, as set forth above the electronic apparatus 100 may include the touch screen 120 as a manipulation part but it is not limited thereto and the electronic apparatus 100 may include another manipulation part instead of the touch screen. For example, the electronic apparatus 100 may receive a user manipulation with respect to a UI displayed on a display included in the electronic apparatus 100 through various input circuitry, such as, for example, and without limitation, a physical button, a touch pad or the like included in the electronic apparatus 100.

The processor 130 may include various processing circuitry that controls overall operation of the electronic apparatus 100. The processor 130 may include various processing circuitry, including, for example, and without limitation, a central processing unit (CPU), a RAM, a ROM and a system bus. Hereinabove, it is described that the processor 130 includes one CPU but the processor 130 may include a plurality of CPUs (or may be embodied as a dedicated processor, a digital signal processor (DSP) or a System on chip (SoC), etc.), but is not limited thereto.

The processor 130 may control the touch screen 120 to display a substantially circular UI to control the display apparatus 200.

According to an example embodiment, the processor 130 may control the touch screen 120 to display the substantially circular UI based on a user manipulation.

According to another example embodiment, it is possible to automatically display the substantially circular UI without a user manipulation. For example, when the electronic apparatus 100 is connected with the display apparatus 200, the processor 130 may control the communicator 110 to receive state information of the display apparatus 200 and if it is determined that an image of a viewpoint of a panoramic image is displayed on the display apparatus 200 based on the received state information, the processor 130 may control the touch screen 120 to display the substantially circular UI.

For example, when the display apparatus 200 is connected with electronic apparatus 100, metadata of an image displayed on the display apparatus 200 is checked and if it is determined that the displayed image is an image of a viewpoint of a panoramic image, state information indicating that the viewpoint of the panoramic image is being displayed may be transmitted to the electronic apparatus 100. The electronic apparatus 100 may receive the state information and determine what viewpoint of image of the panoramic image is being displayed on the display apparatus 200.

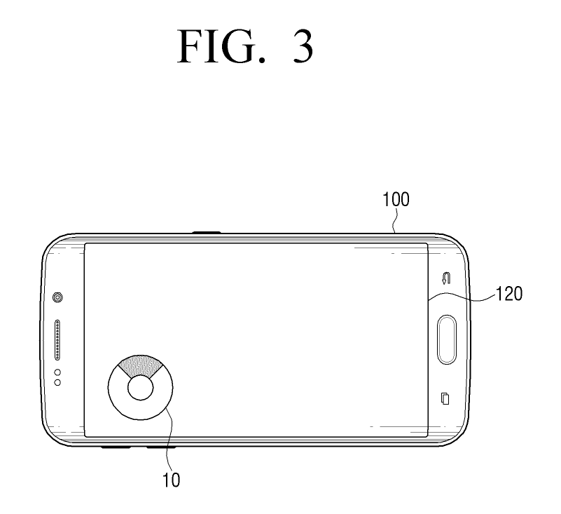

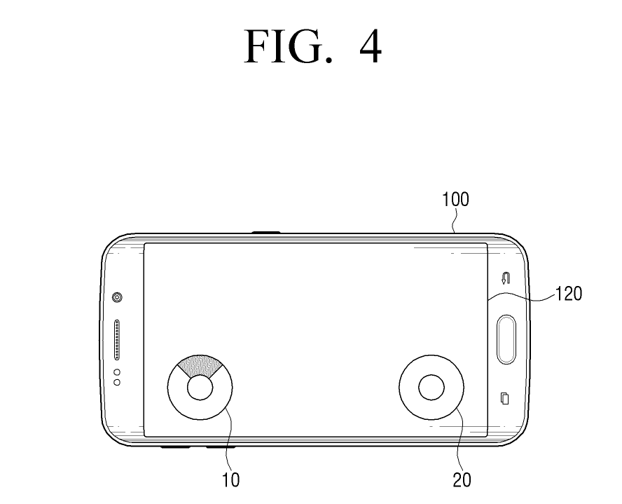

FIGS. 3 and 4 are diagrams illustrating various example embodiments of screen configurations including a substantially circular UI(s) provided by the electronic apparatus 100 according to example embodiments of the present disclosure.

The electronic apparatus 100 may display a substantially circular UI 10 as illustrated in FIG. 3 on the touch screen 120. The substantially circular UI 10 is a touch sensing UI and the electronic apparatus 100 may transfer a different control signal according to a touch point, to the display apparatus 200.

The electronic apparatus 100 may further display another substantially circular UI 20 to control the electronic apparatus 100 as illustrated in FIG. 4 on the touch screen 120 in addition to the substantially circular UI 10 to control the display apparatus 200. It is possible to display the plurality of substantially circular UIs to control the respective display apparatus 200 and electronic apparatus 100 but the electronic apparatus 100 may display only one substantially circular UI and have a control authority over the display apparatus 200 or over the electronic apparatus 100 based on a situation.

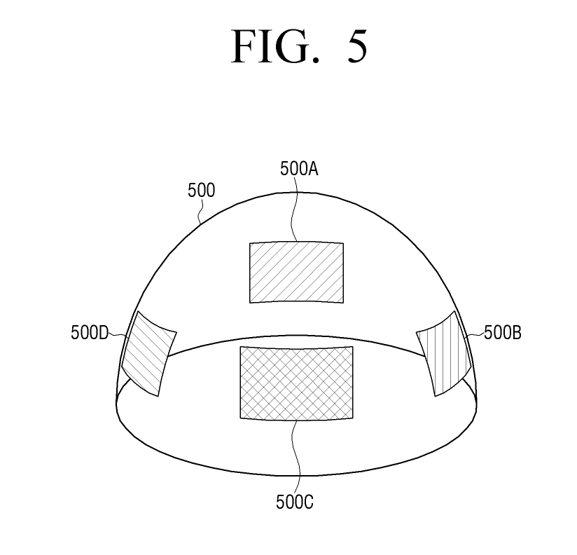

FIG. 5 is a diagram illustrating an example panoramic image that the display apparatus 200 displays and more particularly illustrating a 360 degree panoramic image (e.g., a spherical image).

Referring to FIG. 5, the display apparatus 200 may display images of some viewpoints of the entire panoramic image 500. For example, as illustrated in FIG. 5, an image of a first viewpoint 500A, an image of a second viewpoint 500B, an image of a third viewpoint 500C and an image of a fourth viewpoint 500D may be displayed on the display apparatus 200. As an example of an actual place, if a panoramic image 500 is photographed on a mound of a baseball park, a home plate is photographed in the image of first viewpoint 500A, a third base is photographed in the image of the second viewpoint 500B, a second base is photographed in the image of the third viewpoint 500C and a first base is photographed in the image of the fourth viewpoint 500D.

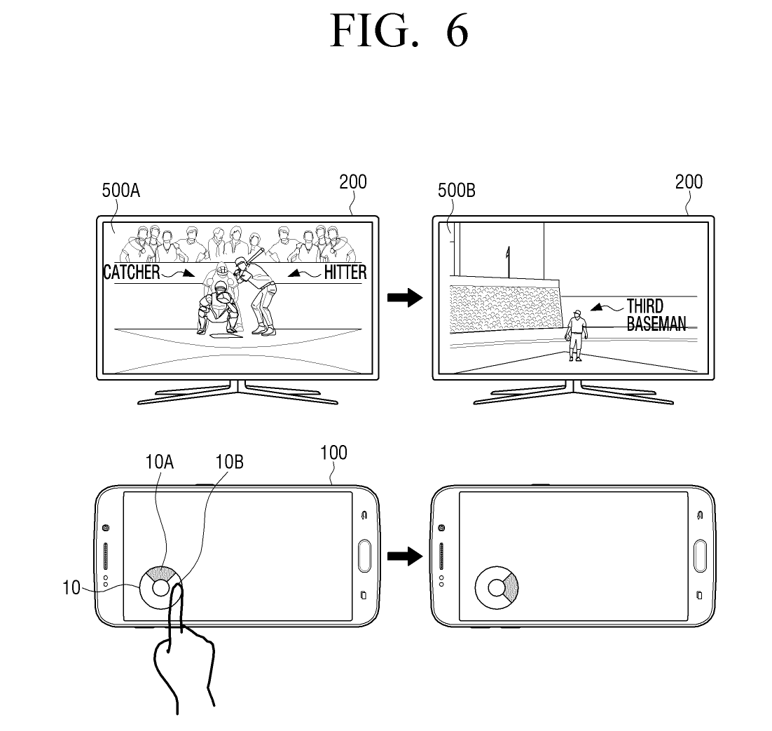

FIGS. 6, 7 and 8 are diagrams illustrating example methods of moving a viewpoint of a panoramic image displayed on the display apparatus 200 using the electronic apparatus 100 according to various example embodiments of the present disclosure. In describing drawings of FIGS. 6 to 8, FIG. 5 is also referred to.

FIG. 6 is a diagram illustrating a situation of moving a viewpoint in order to display the image of the second viewpoint 500B using the substantially circular UI 10 of the electronic apparatus 100 in a state that the display apparatus 200 displays the image of the first viewpoint 500A of the panoramic image 500.

Referring to FIG. 6, in a state that the display apparatus 200 displays the image of first viewpoint 500A of the panoramic image 500, in response to a second point 10B of the substantially circular UI 10 displayed on the electronic apparatus 100 being touched, the processor 130 controls the communicator 110 to transmit a control signal to display an image of a viewpoint matching (e.g., corresponding to) the touched point, or the image of the second viewpoint 500B, to the display apparatus 200. Accordingly, a viewpoint displayed of the display apparatus 200 is moved from the image of the first viewpoint 500A to the image of the second viewpoint 500B.

Meanwhile, in order to notify or inform a user of a viewpoint of an image displayed on the display apparatus 200, a part corresponding to the viewpoint may be displayed distinctively from other parts of the substantially circular UI 10 displayed on the electronic apparatus 100. For example, as illustrated in FIG. 6, while the image of the first viewpoint 500A is displayed on the display apparatus 200, a first part 10A of the substantially circular UI 10 of the electronic apparatus 100 may be highlighted and while the image of the second viewpoint 500B is displayed on the display apparatus 200, the second point 10B of the substantially circular UI 10 may be highlighted.

For example, if the electronic apparatus 100 is connected with the display apparatus 200 in a situation that the display apparatus 200 displays the image of the first viewpoint 500A, the display apparatus 200 may transmit state information including information regarding a viewpoint of the image which is currently displayed. As illustrated in FIG. 6, the processor 130 may highlight the first point 10A corresponding to the first viewpoint based on the received state information. If a touch on the second point 10B is sensed, the processor 130 may highlight the second point 10B based on the sensed result.

The panoramic image 500 may be stored in the display apparatus 200 or in a memory (not illustrated) of the electronic apparatus 100. Referring to FIG. 6, if a panoramic image is stored only in the electronic apparatus 100 and not stored in the display apparatus 200, the electronic apparatus 100 transmits the image of the second viewpoint 500B and a control signal to display the image of the second viewpoint 500B to the display apparatus 200. If the panoramic image is stored in the display apparatus 200, the electronic apparatus 100 does not transmit the image of the second viewpoint 500B. Instead, the electronic apparatus 100 transmits information regarding the second viewpoint and a control signal to the display the image of the second viewpoint 500B to the display apparatus 200. The processor 130 may determine whether the panoramic image is stored in the display apparatus 200 based on the state information received from the display apparatus 200.

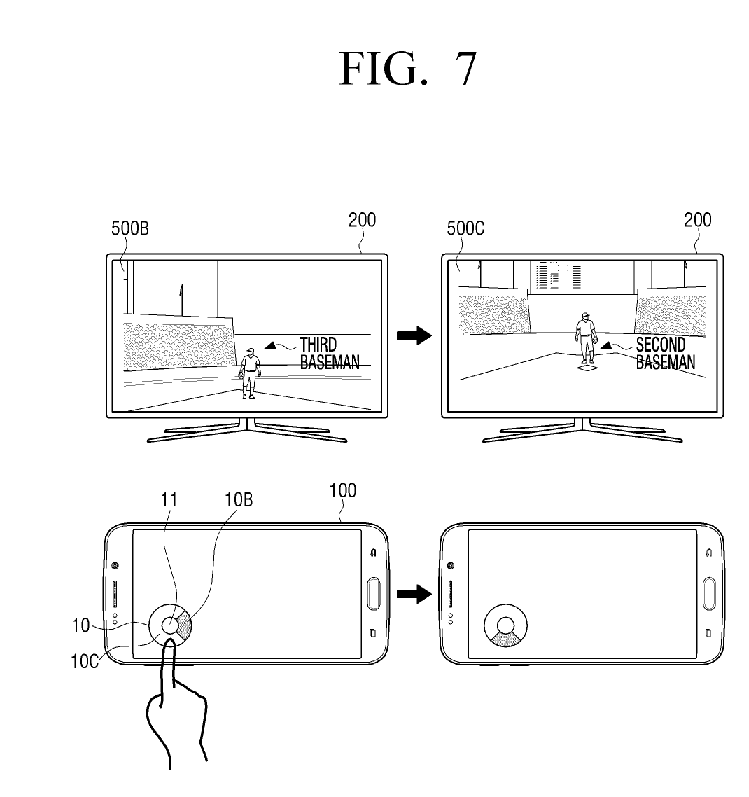

FIG. 7 is a diagram illustrating an example of moving a viewpoint to the image of the third viewpoint 500C using the substantially circular UI 10 of the electronic apparatus 100 in a state that the display apparatus 200 displays the image of the second viewpoint 500B of the panoramic image 500.

Referring to FIG. 7, in a state that the display apparatus 200 displays the image of the second viewpoint 500B of the panoramic image 500, if a third point 10C of the substantially circular UI 10 displayed on the electronic apparatus 100 is touched, the processor 130 controls the communicator 110 to transmit a control signal to display an image of a viewpoint matching (e.g., corresponding to) the touched point, or the image of the third viewpoint 500C, to the display apparatus 200. Accordingly, a viewpoint of the display apparatus 200 is changed by the image of the second viewpoint 500B being changed to the image of the third viewpoint 500C.

More detailed explanations on a process of transmitting a control signal according to an example embodiment with reference to FIG. 7 are as follows.

If the third point 10C of the substantially circular UI 10 is touched in a state that the image of the second viewpoint 500B matching the second point 10B of the substantially circular UI 10 is displayed on the display apparatus 200, the processor 130 transmits a control signal to display the image of the third viewpoint 500C which is moved from the second viewpoint by, for example, as much as an angle between the second point 10B and the third point 10C with reference to a center 11 of the substantially circular UI 10, to the display apparatus 200 through the communicator 110. In other words, in FIG. 7, the image of the third viewpoint 500C that is about 90 degrees moved in a clockwise direction from the image of the second viewpoint 500B is displayed on the display apparatus 200 because the angle between the second point 10B and the third point 10C with reference to the center 11 is about 90 degrees in a clockwise direction.

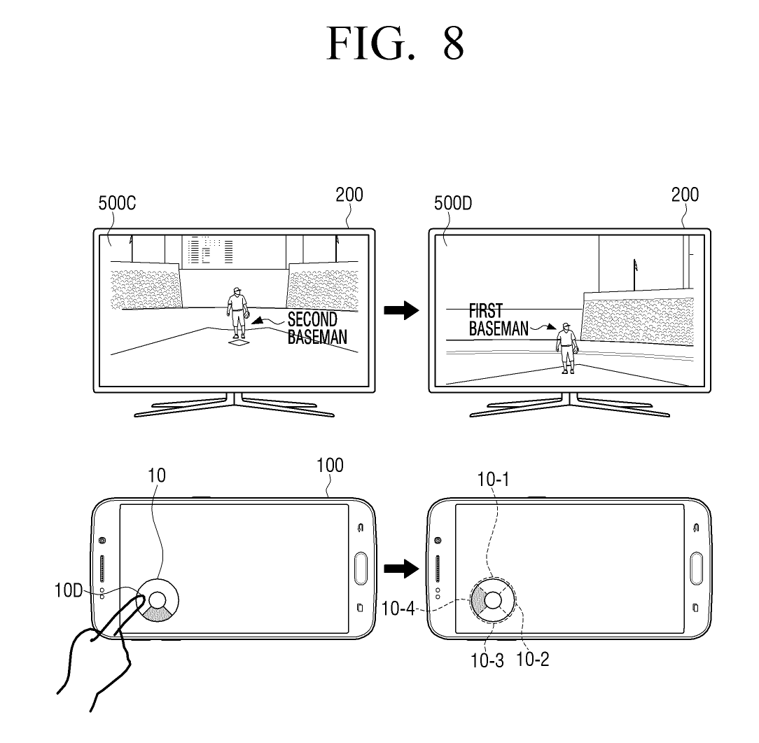

FIG. 8 is a diagram illustrating an example moving a viewpoint to the image of the fourth viewpoint 500D using the substantially circular UI 10 of the electronic apparatus 100 in a state that the display apparatus 200 displays the image of the third viewpoint 500C of the panoramic image 500 according to an example embodiment of the present disclosure.

Referring to FIG. 8, in a state that the display apparatus 200 displays the image of the third viewpoint 500C of the panoramic image 500, if the fourth point 10D of the substantially circular UI 10 displayed on the electronic apparatus 100 is touched, the processor 130 controls the communicator 110 to transmit a control signal to display an image of a viewpoint matching (e.g., corresponding to) the touched point, or the image of the fourth viewpoint 500D, to the display apparatus 200. Accordingly, a viewpoint of the display apparatus 200 is moved from the image of the third viewpoint 500C to the image of the forth viewpoint 500D.

More detailed explanations on a process of transmitting a control signal according to an example embodiment with reference to FIG. 8 are as follows.

The substantially circular UI 10 may be divided into a plurality of areas respectively matching (e.g., corresponding to) a plurality of viewpoints. Referring to FIG. 8, the substantially circular UI 10 is divided into four areas. Each of the plurality of areas matches at least one of a plurality of respective viewpoints of the panoramic image 500. In other words, a first area 10-1 matches the image of the first viewpoint 500A, a second area 10-2 matches the image of the second viewpoint 500B, a third area 10-3 matches the image of the third viewpoint 500C and a fourth area 10-4 matches the image of the fourth viewpoint 500D. In FIG. 8, since a fourth point 10D of the fourth area 10-4 is touched, the processor 130 may control the communicator 110 to transmit a control signal to display the image of the fourth viewpoint 500D matching the touched fourth area 10-4, to the display apparatus 200.

As illustrated in FIG. 8, if the display apparatus 200 displays the image of the fourth viewpoint 500D, the processor 130 may control the touch screen 120 to display the fourth area 10-4 matching the viewpoint of the image 500D displayed on the display apparatus 200 distinctively from the other areas 10-1, 10-2, 10-3. For example, as illustrated in FIG. 8, the fourth area 10-4 may be highlighted. Accordingly, a user may easily recognize a viewpoint of a panoramic image displayed on the display apparatus 200.

According to the various example embodiments, a user may readily move a viewpoint of a panoramic image displayed on the display apparatus 200 through the circular UI provided by the electronic apparatus 100.

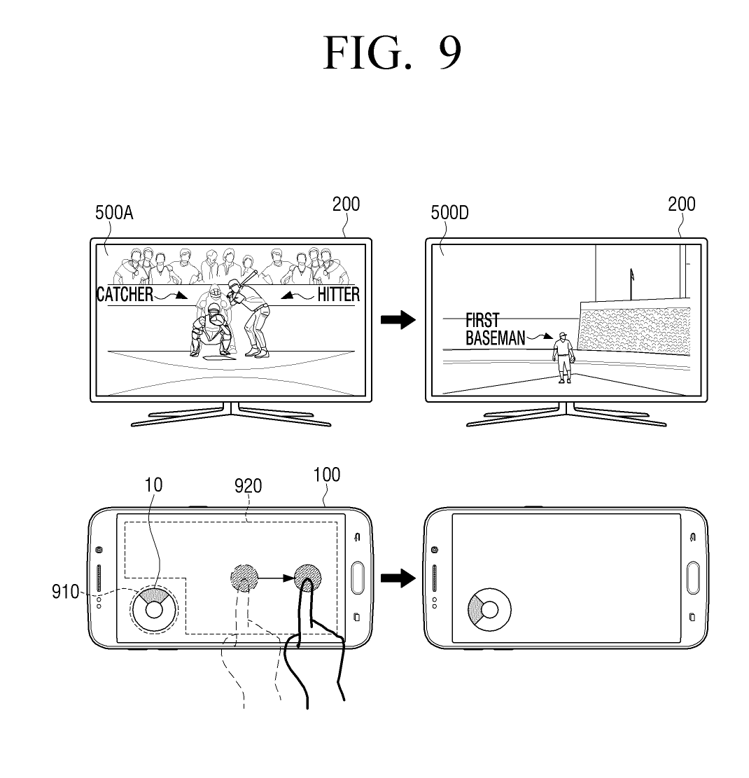

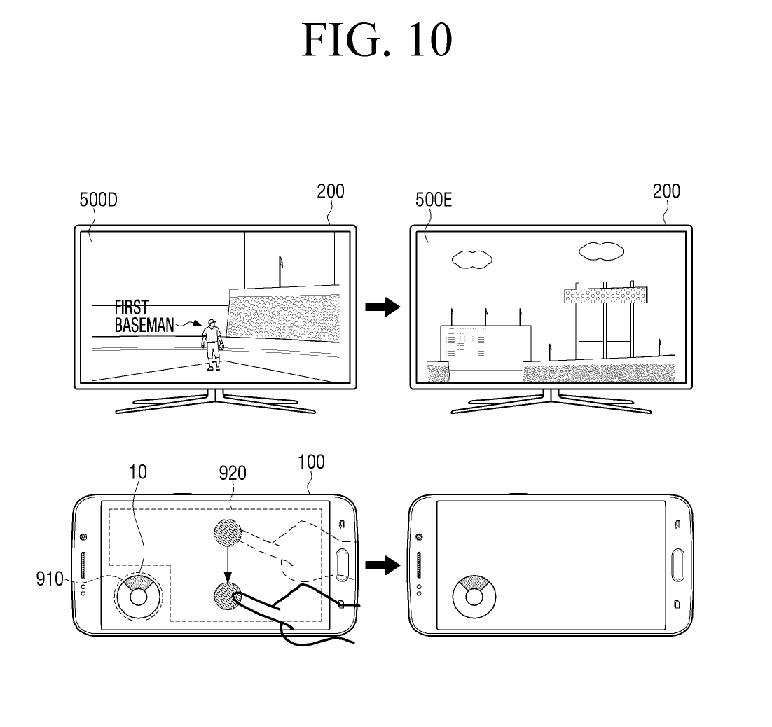

Meanwhile, according to another example embodiment, a viewpoint of a panoramic image displayed on the display apparatus 200 may be moved even without using the substantially circular UI. Regarding this, explanations are described below with reference to FIGS. 9 and 10.

Referring to FIG. 9, if, for example, a dragging (or swiping) manipulation is sensed on a second area 920 that is distinguished from the a first area 910 where the substantially circular UI 10 is displayed on the electronic apparatus 10C, the processor 130 may transmit a control signal to move a viewpoint of the panoramic image displayed on the display apparatus 200 based on a direction in which the dragging manipulation is made, to the display apparatus 200 through the communicator 110. In other words, as illustrated in FIG. 9, if a drag in a right direction is sensed in a situation that the image of the first viewpoint 500A is displayed on the display apparatus 100, a control signal to display the image of the fourth viewpoint 500D that is moved as much as a distance corresponding to a distance moved by the drag from the image of the first viewpoint 500A of the panoramic image 500 in a clockwise direction may be transmitted, from the electronic apparatus 100 to the display apparatus 200.

Referring to FIG. 10, if, for example, a dragging manipulation in a downward direction is sensed on the second area 920 distinguished from the first area 910 where the substantially circular UI 10 is displayed on the electronic apparatus 100, the processor 130 may control the communicator 110 to transmit a control signal to display an image of a fifth viewpoint 500E that is upwardly moved as much as a distance moved by a drag from the image of the first viewpoint 500A of the panoramic image 500 illustrated in FIG. 5, to the display apparatus 200. In other words, as illustrated in FIG. 10, in a state that an image of a viewpoint looking at a baseball park, if there is a dragging manipulation in a downward direction, an image of a viewpoint looking at sky may be displayed on the display apparatus 200.

For an exact or more precise viewpoint movement, it may be beneficial to use a dragging manipulation instead of using the substantially circular UI as explained with reference to FIGS. 9 and 10. For a quick viewpoint change (a direct movement), it may be beneficial to use a touch manipulation on the circular UI as explained with reference to FIGS. 6 to 8.

The electronic apparatus 100 may further include a sensing unit (not illustrated) which senses a movement of the electronic apparatus 100 and may move a viewpoint of the panoramic image displayed on the display apparatus 200 based on a movement of the electronic apparatus 100 sensed by the sensing unit.

The sensing unit may include various sensing circuitry, such as, for example, and without limitation, at least one of a gravity sensor, a geomagnetic sensor, a gyro sensor, an acceleration sensor, etc. and may sense a movement characteristic of the electronic apparatus 100 such as a rotation direction, a rotation angle, a tilt or the like.

For example, the processor 130 may control the communicator 110 to transmit a control signal to move a viewpoint of a panoramic image displayed on the display apparatus 200 based on a movement change, sensed by the sensing unit, of the electronic apparatus 100, to the display apparatus 200.

For example, instead of inputting a dragging manipulation to the right as explained with reference to FIG. 9, even in case that the sensing unit senses the electronic apparatus 100 moving to the left, the processor 130 may transmit a control signal to display from the image of the first viewpoint 500A of the panoramic image 500 illustrated in FIG. 5 to the image of the fourth viewpoint 500D that is moved by as much as a distance that the electronic apparatus 100 moved to the left in a clockwise direction, to the display apparatus 200.

As another example embodiment, instead of inputting a dragging manipulation in a downward direction with reference to FIG. 10, even in case that the sensing unit senses the electronic apparatus 100 being uplifted, the processor 130 may control the communicator 110 to transmit a control signal to display the image of the fifth viewpoint 500E that is moved in a upward direction by as much as the electronic apparatus 100 was moved in a upward direction from the image of the first viewpoint 500A of the panoramic image 500 of FIG. 5.

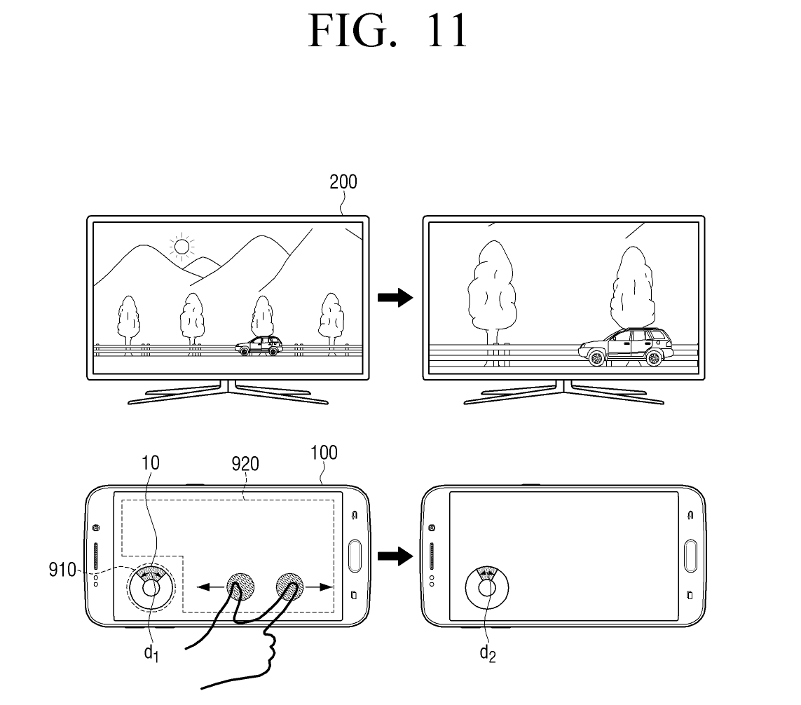

FIG. 11 is a diagram illustrating example operations of zooming in and zooming out a panoramic image displayed on the display apparatus 200 using gesture inputs to the electronic apparatus 100 according to various example embodiments of the present disclosure.

An example gesture used in zooming in/out will be described herein. For example, after two points are touched on the second area 920, if a manipulation of changing a distance of the two points is sensed, the processor 130 may control the communicator 110 to transmit a control signal to zoom in or zoom out an image which is displayed on the display apparatus 100 according to the changed distance.

As illustrated in FIG. 11, if two points are touched on the second area 920 are touched and a manipulation of increasing a distance between the touched two points is sensed, the processor 130 transmits a control signal to zoom in an image displayed on the display apparatus 100, to the display apparatus 200. In this case, since the operation of zooming in the image is carried out, a highlighted area which indicates the viewpoint of the panoramic image displayed on the display apparatus 200 is decreased from d1 to d2. On the other hand, if an operation of zooming out the image is carried out, the width may increase.

Meanwhile, according to an example embodiment, a user may watch image of different viewpoints because the display apparatus 200 and the electronic apparatus 100 may display panoramic images of respectively different viewpoints.

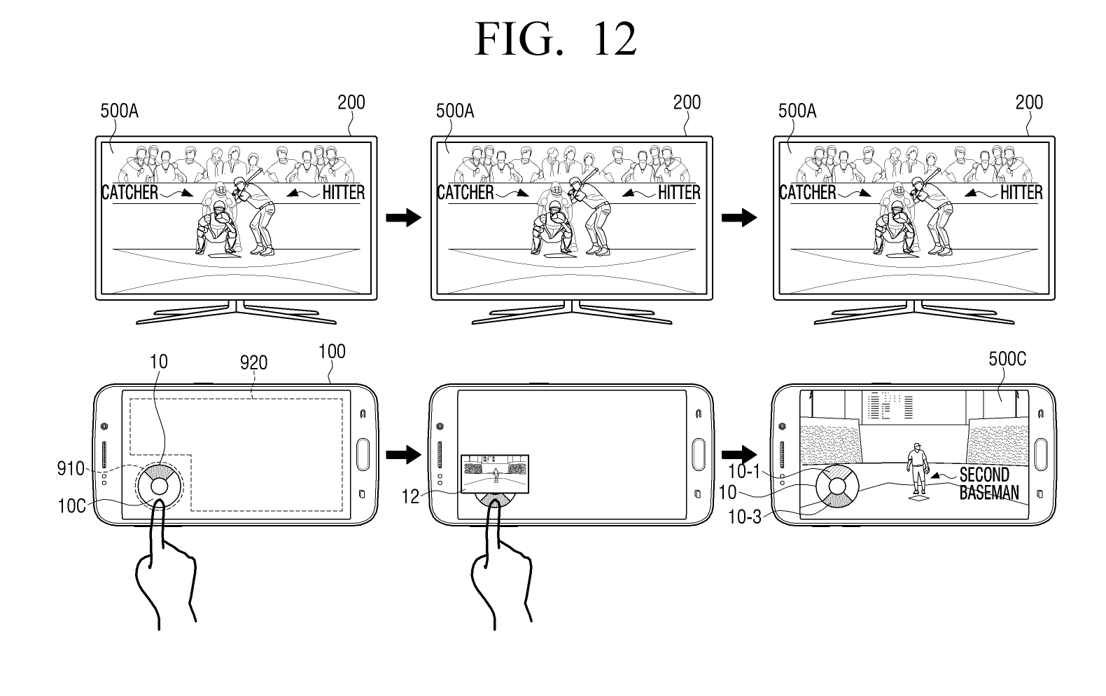

Specifically, if a point on the substantially circular UI displayed on the touch screen 120 is touched for more than a pre-set period of time, the processor 130 may display an image of a viewpoint of the panoramic image matching the point touched for more than the pre-set period of time, on the touch screen 120. These example operations will be described in greater detail below with reference to FIG. 12.

Referring to FIG. 12, if the third point 10C of the substantially circular UI 10 is touched for more than a pre-set period of time, a thumbnail 12 of the image of the third viewpoint 500C matching (e.g., corresponding to) the third point 10C appears and if the thumbnail 12 is dragged and dropped on the second area 920, the image of the third viewpoint 500C may be displayed on the entire area of the touch screen 120. The thumbnail appearance may be omitted and the drag and drop may also not be requested. Thus, with, for example, a manipulation of touching the third point 10C for more than a pre-set period of time, the touch screen may display the image of the third viewpoint 500C on the entire area.

In case that a panoramic image is stored in the display apparatus 200 but not stored in the electronic apparatus 100, if a manipulation of touching the third point 10C is sensed for more than a pre-set period of time, the electronic apparatus 100 may request the display apparatus 200 to provide the image of the third viewpoint 500C, receive the image of the third viewpoint 500C from the display apparatus 200 and display the image of the third viewpoint 500C.

The above description is limited to use a touch manipulation for more than a pre-set period of time on the substantially circular UI but it is not limited thereto. If the touch screen 120 is composed of a pressure sensor, it is also possible to use a manipulation of pressing with power greater than a pre-set power.

Referring to FIG. 12, regarding the substantially circular UI 10, the first area 10-1 of the circular UI 10 may be highlighted to indicate a viewpoint displayed on the display apparatus 200 and the third area 10-3 of the circular UI 10 may be highlighted to indicate a viewpoint displayed on the electronic apparatus 100. Each of the highlighted areas may have different forms for a user to easily discern that one area is for the display apparatus 200 and the other area is for the electronic apparatus 100.

According to the example embodiment, the user may watch the images of respectively different viewpoints of the panoramic image through the display apparatus 200 and the electronic apparatus 100.

If only one substantially circular UI 10 is displayed as illustrated in FIG. 12, the substantially circular UI may be used in controlling each of the images on the display apparatus 200 and the electronic apparatus 100. For example, in a state that the display apparatus 200 and the touch screen 120 respectively display an image of a viewpoint of a panoramic image, if a point of the substantially circular UI 10 is touched and a control authority over the electronic apparatus 100 is set on the substantially circular UI 10, the touch screen 120 may be controlled to display an image of a viewpoint matching the touched point. Alternatively, if a control authority over the display apparatus 200 is set on the substantially circular UI 10, the processor 130 may transmit a control signal to display an image of a viewpoint matching a touch point, to the display apparatus 200.

The processor 130 may set a control authority over the electronic apparatus 100 on the circular UI 10 or set a control authority over the display apparatus 200 based on a user manipulation.

For example, as illustrated in FIG. 12, in a state that the display apparatus 200 displays the image of the first viewpoint 500A of the panoramic image and the touch screen 120 displays the image of the third viewpoint 500C of the panoramic image, if a touch is recognized on the second area 920, the processor 130 sets a control authority over the electronic apparatus 100 on the substantially circular UI 10. Then, a touch manipulation made on the circular UI 10 may be recognized as a manipulation to control an image on the touch screen 120.

On the other hand, if the third area 10-3 of the substantially circular UI 10 corresponding to the image of the third viewpoint 500C displayed on the electronic apparatus 100 is touched, the processor 130 sets a control authority over the electronic apparatus 100 on the substantially circular UI 10. In the same method, if the first area 10-1 of the substantially circular UI 10 corresponding to the image of the first viewpoint 500A displayed on the display apparatus 200 is touched, the processor 130 sets a control authority over the display apparatus 200 on the substantially circular UI 10. Accordingly, a follow-up touch manipulation made on the substantially circular UI 10 may be recognized as a manipulation to control an image of the display apparatus 200.

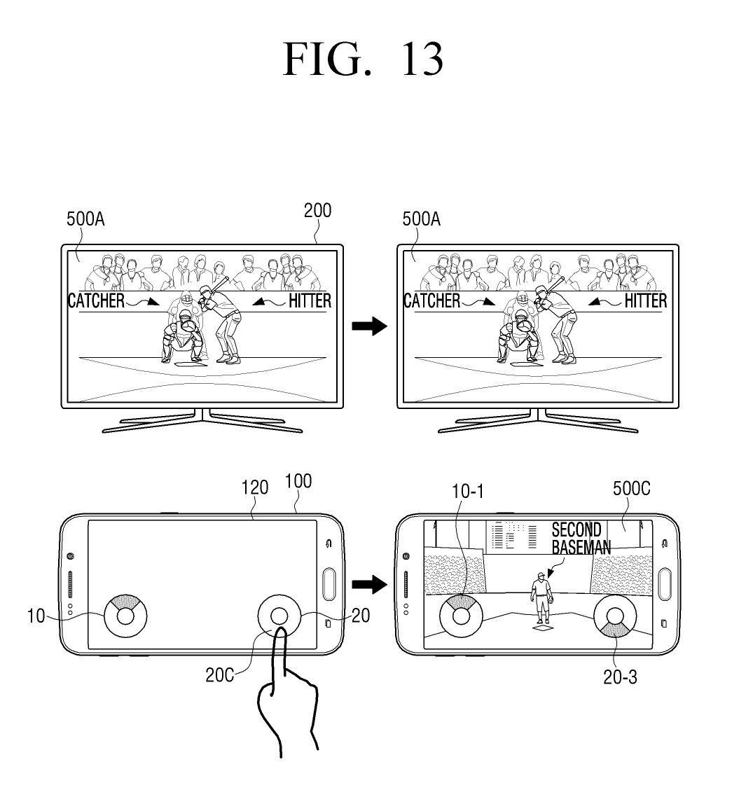

FIG. 13 is a diagram illustrating an example method of displaying an image of a viewpoint of a panoramic image on the electronic apparatus 100 in a method different from the method described with reference to FIG. 12.

Referring to FIG. 13, the processor 130 may control the touch screen 120 to further display a second substantially circular UI 20 to control electronic apparatus 200 in addition to the first substantially circular UI 10 to control the display apparatus 200. In this example, if a third point 20C of the second substantially circular UI 20 is touched, the processor 130 may display the image of the third viewpoint 500C matching (e.g., corresponding to) the third point 20C that is touched on the panoramic image, on the touch screen 120.

For example, if the third point 20C of the second substantially circular UI 20 is touched, the processor 130 may transmit information regarding the third point 20C to the display apparatus 200 and the display apparatus 200 storing the panoramic image may transmit the image of the third viewpoint 500C matching (e.g., corresponding to) the third point 20C to the electronic apparatus 100. The processor 130 may control the touch screen 120 to display the received image of the third viewpoint 500C. If the panoramic image is stored in the electronic apparatus 100, the electronic apparatus 100 may directly display the image of the third viewpoint 500C matching the third point 20C without receiving the image from the display apparatus 200.

In addition, the processor 130 controls the touch screen 120 to display the third area 20-3 of the second substantially circular UI 20 to be highlighted so that a user may recognize a viewpoint of an image displayed on the touch screen 120 and the processor 130 controls the touch screen 120 to display the first area 10-1 of the first substantially circular UI 10 to be highlighted so that the user may recognize a viewpoint of an image displayed on the display apparatus 100.

According to the example embodiment explained with reference to FIG. 13, since the plurality of substantially circular UIs respectively corresponding to the display apparatus 200 and the electronic apparatus 100 are displayed, it is possible to control an image of the display apparatus 200 and an image of the electronic apparatus 100 at the same time.

According to an example embodiment, in a situation that display apparatus 200 and the electronic apparatus 100 display images of different viewpoints at the same time, the images of the display apparatus 200 and the electronic apparatus 100 may be exchanged based on a user manipulation.

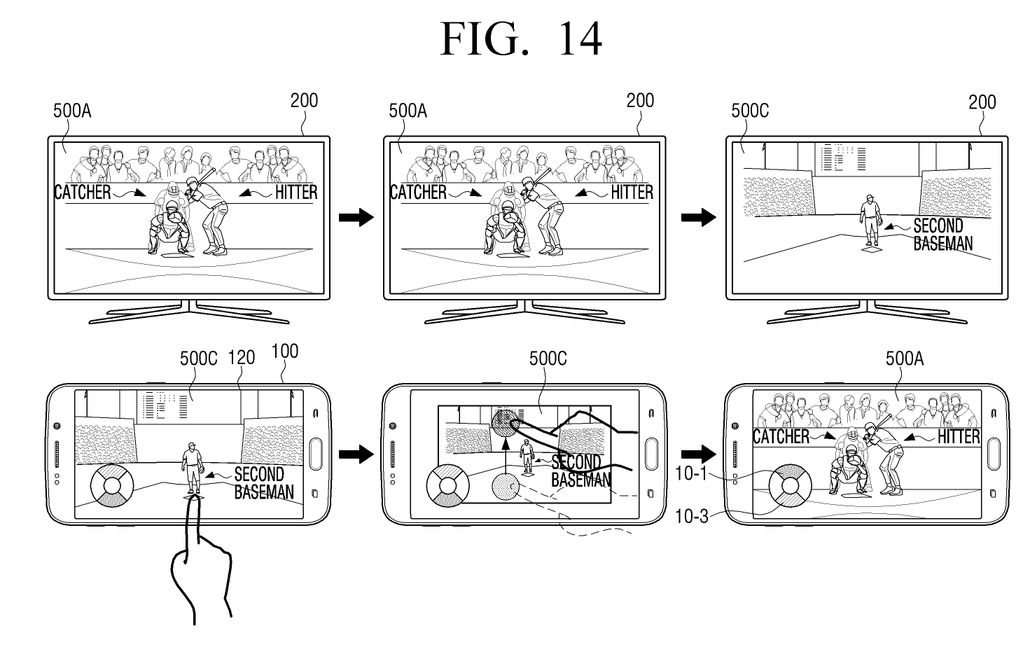

For example, in a state that the display displays an image of the first viewpoint of the panoramic image and the touch screen 120 displays an image of the second viewpoint of the panoramic image, if the image of the second viewpoint displayed on the touch screen 120 is touched and a dragging manipulation in an outside direction of the electronic apparatus 100 is sensed, the communicator 110 may be controlled to display the image of the first viewpoint on the touch screen 120 and to transmit a control signal to display the image of the second viewpoint to the display apparatus 200. Descriptions regarding this operation will be further described in greater detail below with reference to FIG. 14.

Referring to FIG. 14, in a state that the image of the first viewpoint 500A of the panoramic image is displayed on the display apparatus 200 and the image of the third viewpoint 500C of the panoramic image is displayed on the touch screen 120 of the electronic apparatus 100, if the image of the third viewpoint 500C displayed on the touch screen 120 is touched and a dragging manipulation in an outside direction of the electronic apparatus or the outside direction in which the display apparatus 200 is located is sensed, the processor 130 controls the communicator 110 to transmit a control signal to display the image of the third viewpoint 500C on the display apparatus 200, to the display apparatus 200 and controls the touch screen 120 to display the image of the first viewpoint 500A.

In this example, according to an example embodiment, if the image of the third viewpoint 500C is simply touched and a dragging manipulation in an outside direction is sensed, the above described operation may be operated. According to another example embodiment, if the image of the third viewpoint 500C is touched for more than a pre-set period of time and a dragging manipulation to an outside direction is sensed when the image of the third image 500C is a movable state, the above described operation may be performed. If the image of the third viewpoint 500C is touched for more than a pre-set period of time to notify a user that the image of the third viewpoint 500C is in the movable state, a size of the image of the third viewpoint 500C may be decreased as illustrated in FIG. 14.

In the above example, it is explained that the touch manipulation for more than the pre-set period of time is used for exchanging images but it is not limited thereto. If the touch screen 120 includes a pressure sensor, it is also possible to use a manipulation of pressing with power greater than a pre-set power.

After the image exchange, as illustrated in FIG. 14, a highlight form (a light pattern) applied on the first area 10-1 of the substantially circular UI 10 corresponding to the display apparatus 200 is applied to the third area 10-3 and a form (a dark pattern) applied on the third area 10-3 corresponding to the electronic apparatus 100 is applied to the first area 10-1.

If an entire panoramic image is stored in one of the display apparatus 200 and the electronic apparatus 100, when images are exchanged, an apparatus storing the entire panoramic image may transmit an image that the apparatus itself was displaying to the other apparatus and receive information of a viewpoint of the image which was being displayed on the other apparatus. In other words, it is not necessary for the apparatuses to transmit an image to each other and it is only necessary for one of the apparatuses to transmit viewpoint information to the other apparatus. Therefore, an amount of data to be transferred may be decreased.

For example, in a situation that the entire panoramic image is stored only in the display apparatus 200 and the entire panoramic image is not stored in the electronic apparatus 100, if a dragging manipulation illustrated in FIG. 14 is sensed, the processor 130 may receive the image of the first viewpoint 500A displayed on the display apparatus 200, from the display apparatus 200 and transmit information regarding a viewpoint corresponding to the image of the third viewpoint 500C (or information regarding an angle) displayed on the touch screen 120, to the display apparatus 200.

On the other hand, in a state that the entire panoramic image is stored only in the electronic apparatus 100 and the entire panoramic image is not stored in the display apparatus 200, if a dragging manipulation illustrated in FIG. 12 is sensed, the processor 130 may receive information regarding a viewpoint corresponding to the image of the first viewpoint 500A displayed on the display apparatus 200, from the display apparatus 200 through the communicator 110, and may transmit the image of the third viewpoint 500C displayed on the touch screen 120 to the display apparatus 200.

The above example embodiments may be readily used when a user desires to watch an image that was displayed on the electronic apparatus 100 with a small screen, on the display apparatus 200 with a big screen.

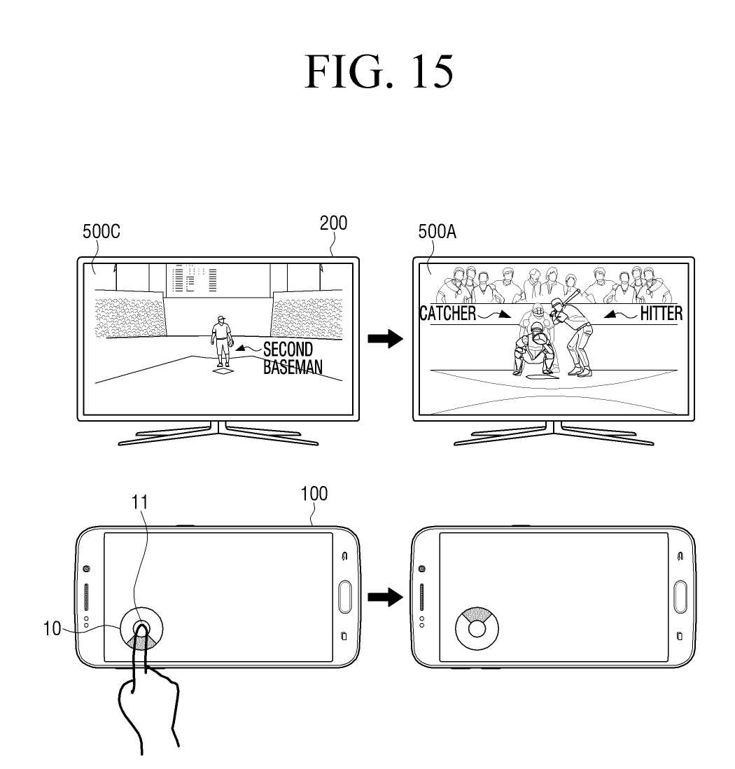

FIG. 15 is a diagram illustrating an example method of moving an image viewpoint according to another example embodiment of the present disclosure.

Referring to FIG. 15, if the center 11 of the substantially circular UI is touched, the processor 130 may control the communicator 110 to transmit a control signal to display an image of a default viewpoint of a panoramic image, to the display apparatus 200. FIG. 15 illustrates that the default viewpoint is set as a first viewpoint and if the center 11 of the substantially circular UI 10 is touched in a state that the image of the third viewpoint 500C is displayed on the display apparatus 200, a control signal to display the image of the first viewpoint 500A is transmitted to the display apparatus 200.

According to the example embodiment, with a manipulation of selecting the center of the substantially circular UI, an image of the panoramic image may return exactly to the image of the default viewpoint.

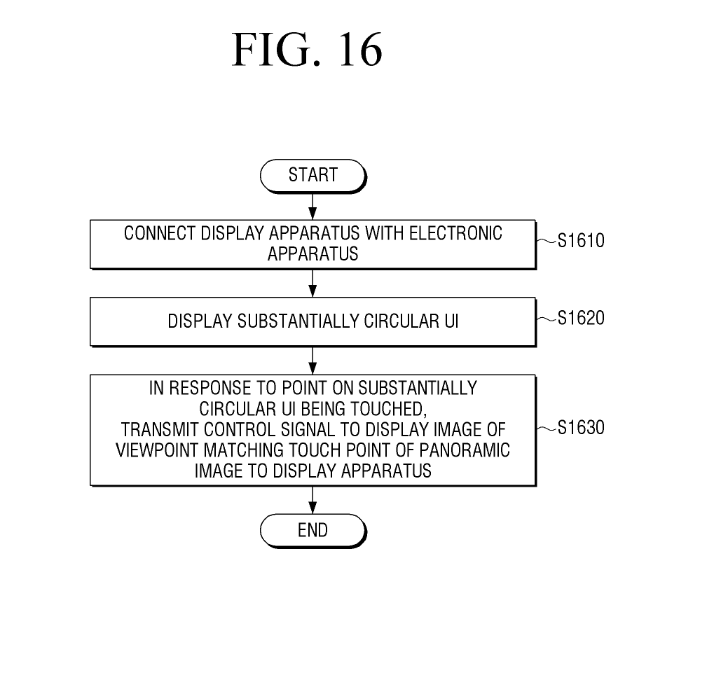

FIG. 16 is a flowchart illustrating an example method of controlling the electronic apparatus 100 according to an example embodiment. Meanwhile, the example method of controlling the electronic apparatus 100 includes the various example embodiments explained with reference to FIGS. 1 to 15 and 17 in addition to the example embodiments explained with reference to FIG. 16. Therefore, repetitive explanations are omitted.

Referring to FIG. 16, the display apparatus 200 displaying an image of a viewpoint of a panoramic image is operably connected with the electronic apparatus 100 in operation S1610.

In this case, the connection may be carried out through various wireless communication methods such as a Bluetooth, NFC, WiFi Direct and the like.

For example, if a panoramic image being displayed on the display apparatus 200 is sensed, the display apparatus 200 may request for a connection to the electronic apparatus 100 and the display apparatus 200 may be automatically connected with the electronic apparatus 100.

If the display apparatus 200 is connected with the electronic apparatus 100, the display apparatus 200 may transmit state information to the electronic apparatus 100. The state information may include information regarding a viewpoint of an image displayed on the display apparatus 200.

When the display apparatus 200 is connected with the electronic apparatus 100, the electronic apparatus 100 displays a substantially circular UI in operation S1620.

Meanwhile, it is not necessary for the UI to be circular and the UI may have various shapes. For example, the UI may be a polygon such as a tetragon, a pentagon and the like. It is unnecessary for the UI to have a closed shape and the UI may be a circular shape or a polygon part of which is opened. In other words, if the UI has a shape appropriate for a panoramic image manipulation, the UI is not limited to a certain shape. In addition, a UI may be called “a mini map” to control the panoramic image in addition to being called “a substantially circular UI.”

If a point on the substantially circular UI is touched, the electronic apparatus 100 transmits a control signal to display an image of a viewpoint matching a touch point of the panoramic image, to the display apparatus 200 in operation S1630.

In this example, the electronic apparatus 100 may transmit information regarding a viewpoint matching the touch point and the control signal to the display apparatus 200 and the display apparatus 200 may display an image of a viewpoint corresponding to the received information regarding the viewpoint of the panoramic image pre-stored in the display apparatus 200. Alternatively, if the panoramic image is not stored in the display apparatus 200 but stored in the electronic apparatus 100, the electronic apparatus 100 may transmit the image of the viewpoint matching the touch point and a control signal or transmit an entire panoramic image, the information regarding the viewpoint matching the touch point and the control signal to the display apparatus 200.

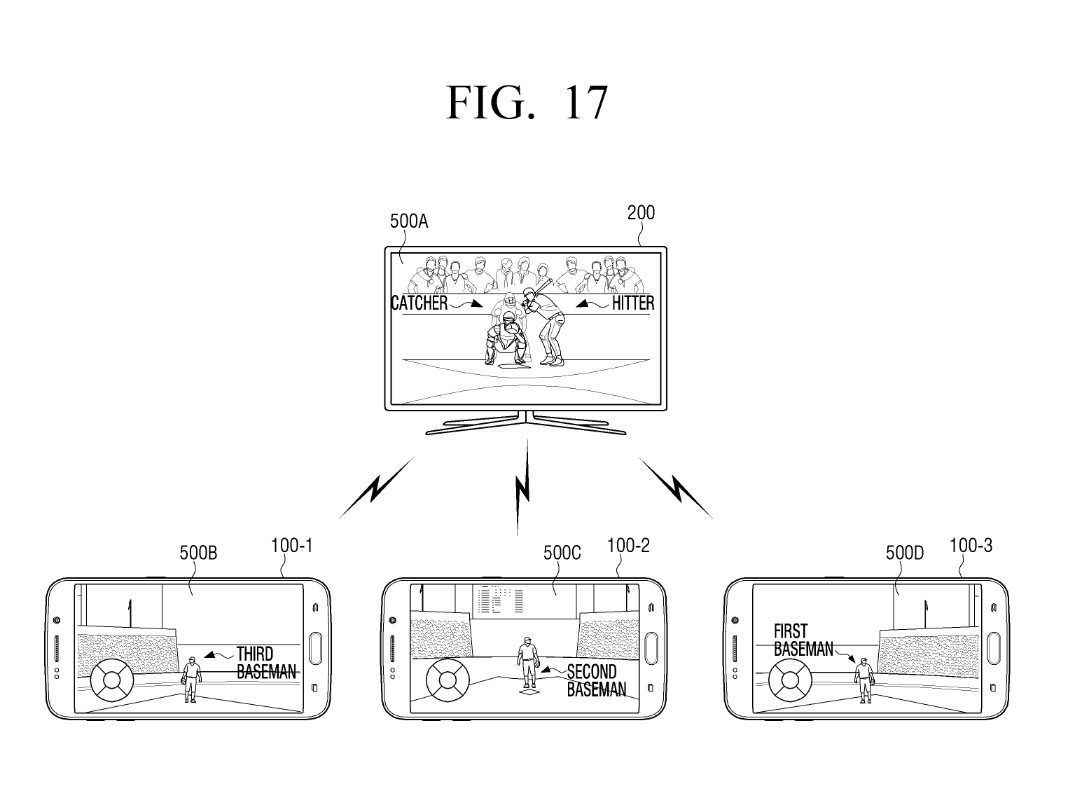

FIG. 17 is a diagram illustrating an example method of displaying images of various viewpoints of a panoramic image on a plurality of apparatuses according to an example embodiment of the present disclosure.

Referring to FIG. 17, a plurality of electronic apparatuses 100-1, 100-2, 100-3 may be operably connected with the display apparatus 200 at the same time.

In a state that the panoramic image is stored in the display apparatus 200 and the image of the first viewpoint 500A of the panoramic image is displayed on the display apparatus 200, the display apparatus 200 may transmit state information to each of the plurality of electronic apparatuses 100-1, 100-2, 100-3, and accordingly, a mode of the plurality of electronic apparatuses 100-1, 100-2, 100-3 may be converted to a panoramic image display mode.

According to a request of the plurality of electronic apparatuses 100-1, 100-2, 100-3, the display apparatus 200 may transmit an image of a viewpoint of the panoramic image to the plurality of electronic apparatuses 100-1, 100-2, 100-3. For example, the plurality of electronic apparatuses 100-1, 100-2, 100-3 may request for an image to the display apparatus 200 through a manipulation on the circular UI.

The plurality of electronic apparatuses 100-1, 100-2, 100-3 display the received image. For example, as illustrated in FIG. 17, the first electronic apparatus 100-1 may display the image of the second viewpoint 500B received from the display apparatus 200, the second electronic apparatus 100-2 may display the image of the third viewpoint 500C received from the display apparatus 200 and the third electronic apparatus 100-3 may display the image of the fourth viewpoint 500D received from the display apparatus 200.

Therefore, a user may watch images of various viewpoints of the panoramic image at once through the plurality of electronic apparatuses 100-1, 100-2, 100-3 and the display apparatus 200.

In the case that the plurality of electronic apparatuses 100-1, 100-2, 100-3 are connected with the display apparatus 200, only one apparatus among these may have a control authority over the display apparatus 200. The apparatus having the control authority may move a viewpoint of the panoramic image displayed on the display apparatus 200 through a manipulation on the substantially circular UI or enlarge or minimize and/or reduce an image. The other electronic apparatuses without the control authority may receive an image from the display apparatus 200 only.

According to the various example embodiments, when a user watches a panoramic image on a big screen such as a TV screen, various functions such as converting a viewpoint by a mobile apparatus, directly moving to a desired viewpoint, enlarging/minimizing an image, watching images of different viewpoints at the same time and the like may be readily controlled.

Meanwhile, the example embodiments may be embodied in a memory medium which can be read by a computer or the like using software, hardware or a combination thereof. By a hardware-based embodiment, the example embodiments may be embodied by using at least one of processing circuitry including, but not limited to a dedicated processor, a CPU, Application Specific Integrated Circuits (ASICs), digital signal processors (DSPs), digital signal processing apparatuses (DSPDs), programmable logic apparatuses (PLDs), field programmable gate arrays (FPGAs), processors, controllers, micro-controllers, microprocessors and an electronic unit for performing another function. In some cases, the example embodiments may be embodied as the processor 130 itself. By a software-based embodiment, the procedures and functions explained in the example embodiments may be respectively embodied as separate software modules. Each of the software modules may perform at least one of the functions and operations explained in the disclosure.

Meanwhile, the method of controlling the electronic apparatus according to the various example embodiments may be stored in a non-transitory readable medium. The non-transitory readable medium may be used by being installed in various apparatuses.

The non-transitory computer readable medium is readable by an apparatus. For example, programs of performing the above-described various methods can be stored in a non-transitory computer readable medium such as a CD, a DVD, a hard disk, a Blu-ray disk, universal serial bus (USB), a memory card, ROM, or the like, and can be provided.

The foregoing example embodiments are merely examples and are not to be construed as limiting the present disclosure. The present disclosure can be readily applied to other types of apparatuses. Also, the description of example embodiments are intended to be illustrative, and not to limit the scope of the claims and their equivalents, and many alternatives, modifications, and variations will be apparent to those skilled in the art.

What is claimed is:

1. An electronic apparatus, comprising:
communication circuitry configured to communicate with a display apparatus configured to display an image of a viewpoint of a panoramic image;
a touch screen configured to display a substantially circular user interface (UI); and
a processor configured to, in response to a point on the substantially circular UI being touched, transmit a control signal to display an image of a viewpoint corresponding to the touched point of the panoramic image to the display apparatus through the communication circuitry.

2. The apparatus as claimed in claim 1, wherein the processor is configured to, in a state that an image of a first viewpoint corresponding to a first point of the substantially circular UI is displayed on the display apparatus, in response to a second point of the substantially circular UI being touched, transmit a control signal to display an image of a second viewpoint that is moved from the first viewpoint by as much as an angle between the first point and the second point with reference to a center of the substantially circular UI, to the display apparatus through the communication circuitry.

3. The apparatus as claimed in claim 1, wherein the substantially circular UI is divided into a plurality of areas respectively corresponding to a plurality of viewpoints.

4. The apparatus as claimed in claim 3, wherein the processor is configured to control the touch screen such that, among the plurality of areas, an area corresponding to a viewpoint of an image displayed on the display apparatus is displayed distinctively from other areas of the plurality of areas.

5. The apparatus as claimed in claim 1, wherein the processor is configured to, in response to a point of the substantially circular UI being touched for more than a pre-set period of time, display an image of a viewpoint corresponding to the touched point of the panoramic image through the touch screen.

6. The apparatus as claimed in claim 1, wherein the processor is configured to, in a state that the display apparatus and the touch screen respectively display an image of a viewpoint of the panoramic image, in response to a control authority over the electronic apparatus being set on the substantially circular UI and a point of the substantially circular UI being touched, control the touch screen to display an image of a viewpoint corresponding to the touched point.

7. The apparatus as claimed in claim 1, wherein the processor is configured to, in a state that an image of a first viewpoint of the panoramic image is displayed on the display apparatus and an image of a second viewpoint of the panoramic image is displayed on the touch screen, in response to an image of a second viewpoint displayed on the touch screen being touched and a dragging manipulation in an outside direction of the electronic apparatus being sensed, control the touch screen to display the image of the first viewpoint and to control the communication circuitry to transmit a control signal to display the image of the second viewpoint, to the display apparatus.

8. The apparatus as claimed in claim 7, wherein the processor is configured to, in response to the dragging manipulation being sensed, through the communication circuitry, receive the image of the first viewpoint from the display apparatus and to transmit viewpoint information corresponding to the image of the second viewpoint to the display apparatus.

9. The apparatus as claimed in claim 1, wherein the processor is configured to control the touch screen to further display a second substantially circular UI in addition to the substantially circular UI and, in response to a point on the second circular UI being touched, to display an image of a viewpoint corresponding to the touched point of the panoramic image on the touch screen.

10. The apparatus as claimed in claim 1, wherein the processor is configured to, in response to a dragging manipulation being sensed on a second area that is distinguished from a first area displaying the substantially circular UI, transmit a control signal to move a viewpoint of the panoramic image displayed on the display apparatus based on a direction in which the dragging manipulation is made, to the display apparatus through the communication circuitry.

11. The apparatus as claimed in claim 10, wherein the processor is configured to, in response to two points being touched on the second area and a manipulation of changing a distance between the two points being sensed, control the communication circuitry to transmit a control signal to zoom in or zoom out an image displayed on the display apparatus based on the changed distance, to the display apparatus.

12. The apparatus as claimed in claim 1, wherein the processor is configured to, in response to a center of the substantially circular UI being touched, control the communication circuitry to transmit a control signal to display an image of a default viewpoint of the panoramic image to the display apparatus.

13. The apparatus as claimed in claim 1, further comprising:
a sensor configured to sense a movement of the electronic apparatus,
wherein the processor is configured to control the communication circuitry to transmit a control signal to move a viewpoint of the panoramic image displayed on the display apparatus based on a movement change of the electronic apparatus sensed by the sensor, to the display apparatus.

14. The apparatus as claimed in claim 1, wherein the processor is configured to control the communication circuitry to receive state information from the display apparatus and, in response to determining that an image of a viewpoint of the panoramic image is displayed on the display apparatus based on the received state information, to control the touch screen to display the substantially circular UI.

15. A method of controlling an electronic apparatus, comprising:
operably connecting a display apparatus configured to display an image of a viewpoint of a panoramic image with the electronic apparatus;
displaying a substantially circular UI; and
in response to a point of the substantially circular UI being touched, transmitting a control signal to display an image of a viewpoint corresponding to the touched point of the panoramic image to the display apparatus.

16. The method as claimed in claim 15, wherein the transmitting comprises, in a state that an image of a first viewpoint corresponding to a first point of the substantially circular UI is displayed on the display apparatus, in response to a second point of the substantially circular UI being touched, transmitting a control signal to display an image of a second viewpoint that is moved from the first viewpoint by as much as an angle between the first point and the second point with reference to a center of the substantially circular UI, to the display apparatus through communication circuitry of the electronic apparatus.

17. The method as claimed in claim 15, further comprising, in response to a point of the substantially circular UI being touched for more than a pre-set period of time, displaying an image of a viewpoint corresponding to the touched point of the panoramic image on the electronic apparatus.

18. The method as claimed in claim 15, further comprising, in a state that an image of a first viewpoint of the panoramic image is displayed on the display apparatus and an image of a second viewpoint of the panoramic image is displayed on the electronic apparatus, in response to an image of a second viewpoint displayed on the electronic apparatus being touched and a dragging manipulation in an outside direction of the electronic apparatus being sensed, displaying the image of the first viewpoint on the electronic apparatus and transmitting a control signal to display the image of the second viewpoint, to the display apparatus.

19. The method as claimed in claim 15, further comprises: receiving state information from the display apparatus,
wherein the displaying the substantially circular UI comprises, in response to determining that an image of a viewpoint of the panoramic image is displayed on the display apparatus based on the received state information, controlling the touch screen to display the substantially circular UI.

20. A non-transitory computer-readable recording medium having recorded thereon a program which, when executed by a processor, causes an electronic apparatus to perform operations comprising:
operably connecting a display apparatus which displays an image of a viewpoint of a panoramic image with the electronic apparatus;
displaying a substantially circular UI; and
in response to a point of the substantially circular UI being touched, transmitting a control signal to display an image of a viewpoint corresponding to the touched point of the panoramic image to the display apparatus.
